(19) United States
(12) Patent Application Publication
(10) Pub. No.: US 2012/0087402 A1
(43) Pub. Date: Apr. 12, 2012

(54) IN-SYSTEM METHOD FOR MEASUREMENT OF CLOCK RECOVERY AND OSCILLATOR DRIFT

(75) Inventor: Michel Patoine, Ashton (CA)

(73) Assignee: ALCATEL-LUCENT CANADA INC., Ottawa (CA)

(21) Appl. No.: 12/900,760

(22) Filed: Oct. 8, 2010

(51) Int. Cl. H04B 17/00; G06F 15/00

(52) U.S. Cl. 375/226; 702/176

(57) ABSTRACT

Various embodiments relate to an in-system measurement of clock signals in a communications circuit. A circuit may include a central processing unit and at least one phase error counter (PEC) that uses a measurement clock to determine the accuracy of a target signal. In some embodiments, the PEC may include a counter that compares a clock signal produced by a reference oscillator with the signal of the measurement clock by generating an oscillator phase error based the measured difference during a target period. In some embodiments, the PEC may measure the performance of a clock recovery module by measuring a difference between a produced recovered clock signal and the measurement clock signal, which may be the clock recovery phase error between the two signals. The CPU may also use the measured phase errors to determine other values related to the target signal(s).

### TECHNICAL FIELD

Various exemplary embodiments disclosed herein relate generally to clock measurement and correction.

### BACKGROUND

Many telecommunications systems need time synchronization between devices, such as between base stations. Such time synchronization may enable these systems to, for example, exchange data between its constituent devices. In such instances, such time synchronization may be implemented by maintaining a close relationship in both frequency and phase and may enable the telecommunications devices to handle various actions, such as call hand-offs between nodes in the network. However, in networks such as packet-switching networks, time synchronization through a common service clock may be hindered. For example, while one or more network devices may connect to service clocks directly through line timing, some of these routers or switches within the packet-switching network may only be able to receive the service clock over a timing-over-packet technology. Consequently, some timing algorithms, such as adaptive clock recovery (ACR) or IEEE 1588, may be employed by various devices in the network to recover a service clock and maintain a synchronous clock signal.

Time synchronization in a packet-switched network may be enabled by regularly sending timing packets over the network, instead of a constant bit-stream as done with line timing; such a method may not be possible in certain instances. For the former, the regularity of timing packets may be hindered in a network, as packets may, for example, be queued at each hop and may compete for output processing, based on priority level. In such instances, a packet cannot depart a node until another packet in process has been transmitted. This adds to Packet Delay Variation (PDV), which may be defined as the variability to the arrival of timing packets (of which the packet queue and variable packet sizes are the main determining factors). PDV may be introduced through a network's actual handling of packets as they are passed between devices. Packet-switching networks may also have reroutes for a variety of other reasons, which may further add to PDV.

Existing methods to limit PDV and/or recover a system's service clock to enable time synchronization have used clock-recovery algorithms to average timing packets over long periods of time. Stable clock-reference oscillators may be used in such algorithms, as the long time durations used in limiting PDV in the system need reference oscillators that are stable for long periods of time.

In view of the foregoing, it would be desirable to measure the performance of the clock recovery algorithms. It would also be desirable to measure the performance of the associated reference oscillator.

### SUMMARY

In light of the present need for testing the performance of a clock recovery function and corresponding stable reference oscillator, a brief summary of exemplary test circuits are presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in the later sections.

Various embodiments may relate to an apparatus that measures a clock recovery circuit's performance. The apparatus may comprise an interface that receives a measurement clock signal selectable from one or more clock inputs available to the system. The apparatus may also comprise a timing test circuit. The timing test circuit may comprise a first measurement circuit that measures an oscillator phase difference between the reference oscillator and the measurement clock signal. In some embodiments, the first measurement circuit may further measure a clock recovery phase difference between the measurement clock output and the output of the clock recovery function. In alternative embodiments, the timing circuit may also include a second measurement circuit that measures a clock recovery phase difference between a measurement clock signal and the output of the clock recovery function. In some embodiments, the timing test circuit may be used to test a plurality of oscillators and clock recovery functions. The apparatus may also comprise of a CPU, capable of processing the data from the measuring circuits. The apparatus may also comprise of a user interface to which the CPU may configure the test circuitry and may provide the processing results.

Various embodiments may also relate to a method to measure internal clock performance. The method may comprise a first measurement circuit in a timing circuit receiving a reference oscillator phase from a reference oscillator included in the timing circuit. The method may also comprise receiving a measurement clock phase from a measurement clock signal received through an interface from a measurement clock. The method may also comprise measuring an oscillator phase difference between the reference oscillator phase and the measurement clock phase. In some embodiments, the method may also comprise measuring a clock recovery phase difference between the measurement clock signal and the recovered clock signal.

It should be apparent that, in this manner, various exemplary embodiments enable an in-system apparatus and method for measuring clock performance. Particularly, by using available components in a communications apparatus for in-system measurement of drift in the reference oscillator and clock recovery performance, considerable costs may be saved through the inclusion of measurement circuitry within each communications device, while also ensuring accurate measurement of the clock performance.

### BRIEF DESCRIPTION OF THE DRAWINGS

In order to better understand various exemplary embodiments, reference is made to the accompanying drawings wherein:

FIG. 1 illustrates a block diagram of an exemplary communications circuit;

FIG. 2 illustrates a block diagram of another exemplary communications circuit;

FIG. 3 illustrates an exemplary phase error counter;

FIG. 4 illustrates another exemplary phase error counter;

FIG. 5 illustrates an exemplary rate comparator;

FIG. 6 illustrates a flowchart of an exemplary method to measure phase error; and

FIG. 7 illustrates a flowchart of another exemplary method to measure phase error.

### DETAILED DESCRIPTION

Referring now to the drawings, in which like numerals refer to like components or steps, there are disclosed broad aspects of various exemplary embodiments.

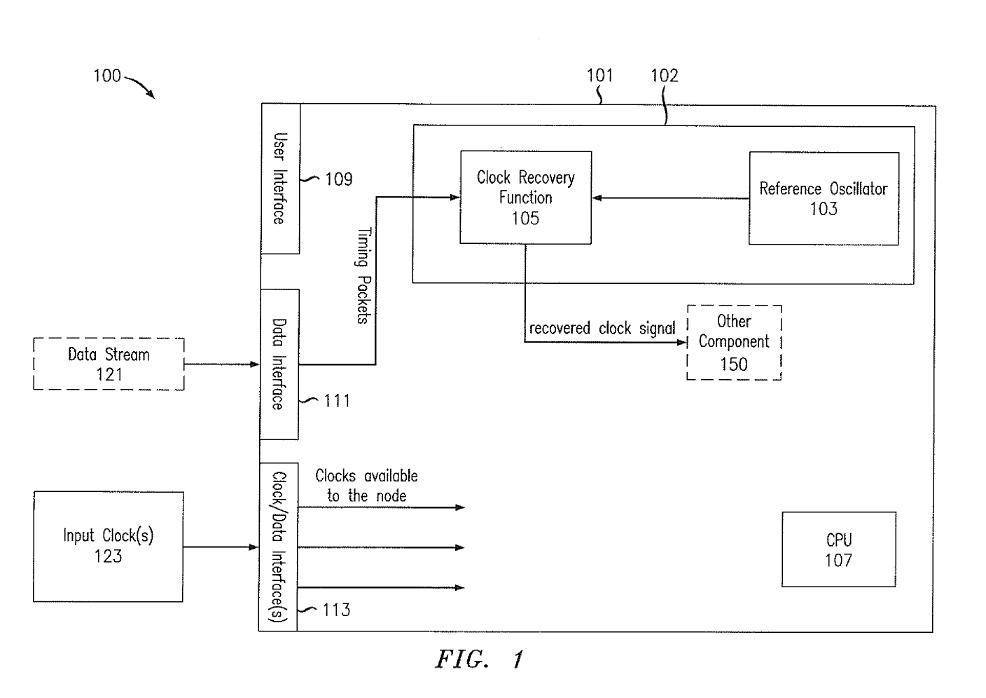

FIG. 1 illustrates a block diagram of an exemplary communications circuit. Communications device 100 may comprise a communications circuit 101, a data stream 121, and an input clock or input clocks 123. Communications circuit 100 may comprise a timing circuit 102 that may include a reference oscillator 103 and a clock recovery module 105. The communications circuit 101 may also include a user interface (UI) 109, a data interface 111, a clock interface 113, and a central processing unit (CPU) 107. The CPU 107 may be part of the clock recovery module 105, or exist as a separate entity within the communications circuit 101.

Communications circuit 101 may be a component of the communications device 100. In some embodiments, the communications circuit 101 may comprise hardware that receives data packets from the data stream 121 and one or more clock signals from the input clocks 123. Input clocks 123 may be derived from dedicated clock inputs or from the data interfaces. In some embodiments, the communications circuit 101 may include a timing circuit 102 that may act as a timing-synchronization circuit by using various internal components, such as the reference oscillator 103, to enable synchronization based on the information included in the data stream 121. For example, in one embodiment, the clock recovery module 105 in the timing circuit 102 may use the included reference oscillator 103 to implement a clock recovery algorithm based on the timing packets received from the data stream 121 through the data interface 111 in the communications circuit 101.

Reference oscillator 103 may be an oscillator included within the communications device 100. In some embodiments, the reference oscillator 103 may be an internal component of the timing circuit 102 included within the communications circuit 101. Reference oscillator 103 may be, for example, an oven-controlled crystal oscillator (OXCO) or a temperature-controlled crystal oscillator (TCXO). Timing circuit 102 of the communications device 100 may use the reference oscillator 103, for example, as an internal reference clock signal for timing operations. Clock recovery module 105 may also, in some embodiments, implement clock recovery algorithms using the reference oscillator 103 as a stable reference for synchronization to the timing conveyed through the timing packets.

In some embodiments, however, the reference oscillator 103 may not be stable enough for the requirements of the system. For example, the reference oscillator 103 may ideally operate at a specific reference frequency, but may drift in frequency and/or phase over the lifetime of the communications circuit 101. In some embodiments, the error in the reference oscillator 103 may be a result of microjumps in frequency or phase, with the reference oscillator 103 later settling back to more stable behavior. In other embodiments, however, the reference oscillator 103 may remain in error, indicating that the reference oscillator 103 may be faulty. In some embodiments, the drift in the reference oscillator 103 may occur relatively quickly, such as when the communications device 100 is first powered on after initial assembly (which may be the result, for example, of the oscillator “settling” into normal function). In some embodiments, the reference oscillator 103 may drift over its operational lifetime from the reference frequency and/or phase.

Clock recovery module 105 may be hardware and/or a tangible machine-readable medium that implements a clock recovery algorithm within the timing circuit 102. For example, the clock recovery module 105 may be a circuit that receives timing packets from the data interface 111 in the communications circuit 101 and uses the adaptive clock recovery (ACR) algorithm to adjust a Digitally Controlled Oscillator (DCO), which uses a reference signal from the reference oscillator 103. The ACR algorithm may produce a “recovered” clock signal that is synchronous with the service clock transported over the timing-over-packet protocol. In other embodiments, the clock recovery module 105 may implement other clock recovery algorithms, such as the IEEE 1588 algorithm. In some embodiments, the recovered clock signal may be transmitted to other devices not shown in the communications circuit, which is illustrated as the “other” component 150.

Central processing unit (CPU) 107 may be a processor or microprocessor in the communications circuit that may, for example, process and/or measure the recovered clock timing packets it receives. In some embodiments, the CPU 107 may include the clock recovery module 105. In such instances, the CPU 107 may be a component of the timing circuit 102. In some embodiments, the CPU 107 may be a processor or microprocessor in the communication circuit 101; in some embodiments, the CPU 107 may not necessarily be related to the clock recovery function or timing circuit.

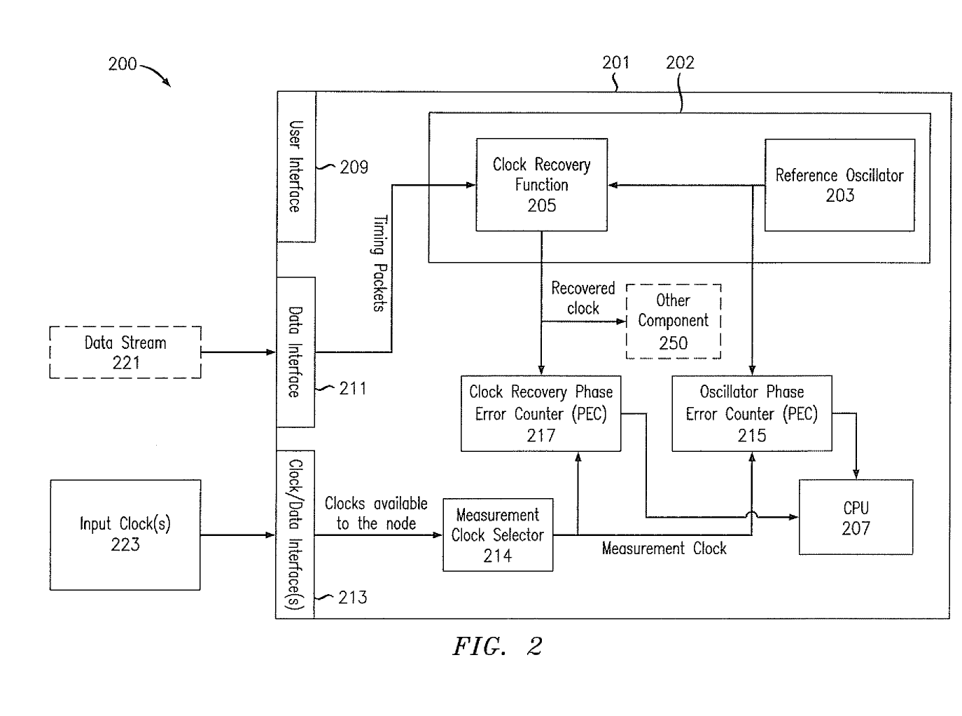

In some embodiments, the CPU 107 may make measurements with respect to the performance of the clock recovery function and the reference oscillator 103, using a small amount of incremental circuitry. For example, as will be discussed in further detail below in relation to FIGS. 2-7, the CPU 107 may determine the frequency error, time interval (e.g., target period) error, and other values related to such measurements. In some embodiments, the CPU 107 may also adjust the parameters for measurement, for example, adjusting the frequency of the inputs.

User interface (UI) 109 in the communications circuit 101 may receive data from one or more components included in the communications device 100, the communications circuit 101, and/or the timing circuit 102 and may display or transmit such data for a user to assess. In some embodiments, the UI 109 may be a GUI or other terminal that enables access to the communications device 100. In some embodiments, the UI 109 may enable remote access. Alternatively, the UI 109 may enable local access for the user. UI 109 may enable the user to send control signals to the CPU 107 or other components for control or to start clock measurements. In some embodiments, the UI 109 may, for example, display the results of an oscillator and/or clock performance measurement, while transmitting user control signals made in response to the display.

Data interface 111 may be an interface included in the communications circuit 101 that receives data packets from the data stream 121. Data interface may be an interface configured to receive data based on the protocol of the data packet. For example, the data interface 111 may be an interface that receives Asynchronous Transfer Mode (ATM) cells, Ethernet frames, or similar packets, based on the protocol used in the data stream 121. In some embodiments, the data interface may extract timing packets from the data stream for further processing by the clock recovery module 105. In alternative embodiments, the clock recovery module may tap the communications line that is transferring data packets to other components of the communications circuit 101 and may use the timing packets included in the data stream to implement a timing recovery algorithm.

Data stream 121 may be in the form of a plurality of data packets received by the communications device 100. The data packets in data stream 121 may be, for example, Internet Protocol (IP) packets sent from one or more other devices in the communications network, some of which may contain timing information. A person of ordinary skill upon reading this description would be aware of similar data packets, some of which may contain timing information carried over protocols such as Ethernet, Frame Relay (FR), Asynchronous Transfer Mode (ATM), High-Level Data Link Control (HLDC), or Multiprotocol Label Switching (MPLS) protocols.

Clock interface 113 may be an interface in the communications circuit 101 that receives one or more clock signals from the input docks 123. In some embodiments, the input clocks 123 and the clock interface 113 may be components included in the communications circuit 101. In some embodiments, the clock interface 113 may receive a plurality of clock inputs and may produce one measurement clock signal used for reference when measuring the clock recovery performance of the clock recovery module 105 and the performance of the reference oscillator 103. In some embodiments, the clock interface 113 may select from a plurality of the input clock signals from the input clock 123 to produce the measurement clock signal.

Input clock or clocks 123 may be used by the communications circuit 101 to enable system synchronization. Input clocks 123 may be one or more clocks that may be measured by the communications circuit 101. In some embodiments, the input clocks 123 may be dedicated system clocks transmitted to the clock interface 113; in alternative embodiments, the input clocks 123 may be derived from the data interface 111. Input clocks 123 may be one or more stratum-0 (e.g., GPS) or stratum-1 traceable clocks. In some embodiments, the communications circuit 101 may use the input clock signal from the input clocks 123 for regular operation, while using the output of the “timing-over-packet” clock recovery module 105 for backup. In such instances, the communications circuit 101 may measure the error in the reference oscillator 103 and/or the clock recovery module 105, while the input clocks 123 are still available to the communications circuit 101.

FIG. 2 illustrates a block diagram of another exemplary communications circuit. Communications device 200 of FIG. 2 may be similar to the communications device 100 of FIG. 1, where the communications circuit 201, the data stream 221 and the input clocks 223 may act in a similar manner to the components 101, 121, and 123 in the communications device 100. Similarly, various components of the communications circuit 201, including the reference oscillator 203 and the clock recovery module 205 of the timing circuit 202, along with the CPU 207, the UI 209, the data interface 211 and the clock interface 213 in the communications circuit 201 acting in a similar manner to their like components 102-113 in the communications circuit 101 of FIG. 1. Communication circuit 201 may also include, for example a measurement clock selector 214 and an oscillator phase error counter 215. In some embodiments, the communication circuit 201 may also include a clock recovery phase error counter 217.

Measurement clock selector 214 may receive a plurality of clock signals and output a single clock signal that may be used by the communications circuit 201, for example, as a reference clock. In some embodiments, the communications circuit 201 through the clock/data interface(s) 213 may receive a plurality of clocks that are available to be used by components of the circuit. The plurality of clocks may come in, for example, on dedicated clock inputs or data interfaces. Measurement clock selector 214 may, for example, receive one or more of such clocks and may select a clock to be used as a reference, measurement clock in further operations.

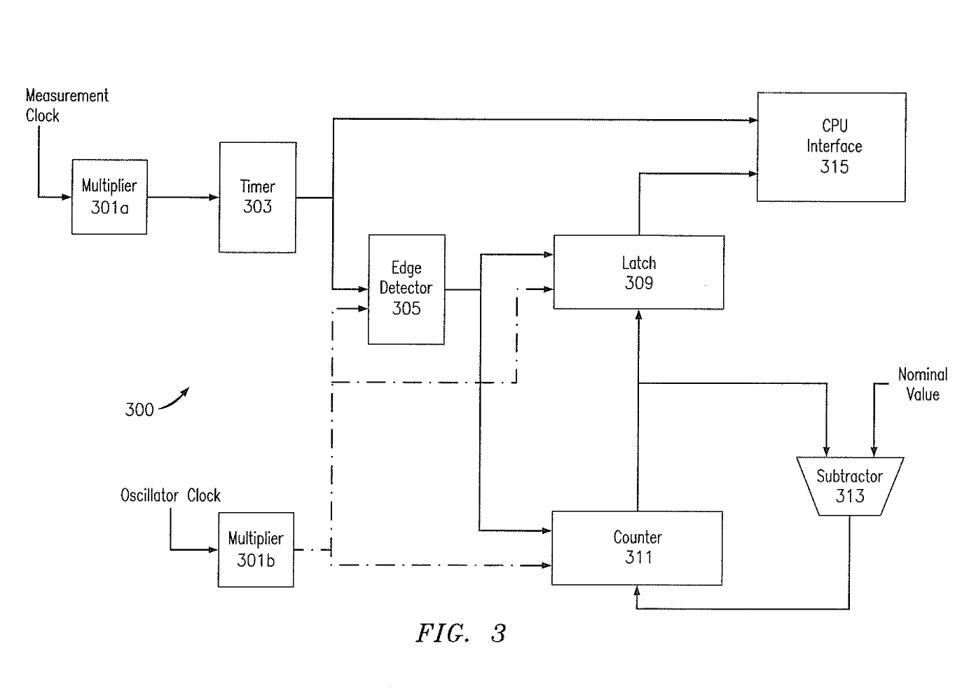

Oscillator phase error counter (PEC) 215 may be a hardware circuit or a tangible machine-readable medium implemented by the CPU 207 that receives the reference oscillator signal from the reference oscillator 203 and the measurement clock signal from the clock interface 213 and may produce an oscillator phase difference based on these received signals. In some embodiments, the oscillator PEC 215 may be configured in a programmable hardware component, such as a field-programmable gate array (FPGA). As will be discussed in relation to FIG. 3, the oscillator PEC 215 may modify the reference oscillator signal frequency and/or the measurement clock signal frequency before determining the oscillator phase difference. This may be done, for example, to increase the granularity of the measured oscillator phase difference.

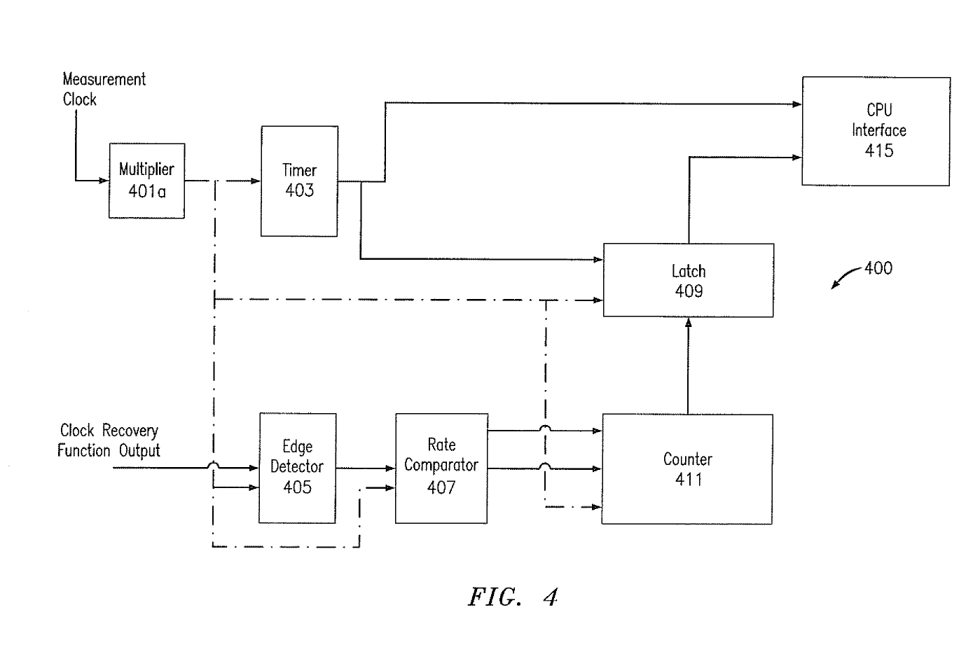

Clock recovery phase error counter (PEC) 217 may be a hardware circuit or a tangible machine-readable medium implemented by the CPU 207 that receives a clock signal from the clock recovery function 205 and the measurement clock signal from the clock interface 213 and may produce a clock recovery phase difference based on these received signals. As will be discussed in relation to FIG. 4, the clock recovery PEC 217 may modify the measurement clock signal to increase the granularity of the measured clock recovery phase difference.

FIG. 3 illustrates an exemplary phase error counter. Phase error counter 300 may be similar to the oscillator phase error counter 215 in the test circuit 202 of FIG. 2. In some embodiments, communication circuit 201 may also use the phase error counter 300 to measure and enable analysis of the behavior of a clock recovery reference oscillator, which may be similar to the reference oscillators 103, 203. In such instances, the phase error counter 300 may measure the displacement of the clock recovery reference oscillator with a measurement clock signal. The displacement of the clock recovery reference oscillator, which may be derived from the oscillator phase difference, may be used by the CPU 207 in the communication circuit 201 to identify oscillator behavior, such as microjumps and frequency errors, and may also be used to identify defective or non-functional oscillators. The illustrative embodiment of the phase error counter 300 may include multipliers 301a-b, a timer 303, an edge detector 305, a latch 309, a counter 311, a subtractor 313, and a CPU Interface 315. The CPU interface may interface to a CPU or microprocessor such as CPU 207 in FIG. 2.

Multipliers 301a-b may be analog or digital circuits that multiply an input signal by another non-zero constant. Phase error counter (PEC) 300 may use the multipliers 301a-b to increase the frequency of at least one of the input signals, which may ensure that the resultant nominal cycle period of the modified oscillator clock divides evenly into the sampling period established by the timer and the modified measurement clock. In some embodiments, multipliers 301a-b may be replaced with dividers to achieve this purpose. PEC 300 may also use at least one of the multipliers 301a-b, on at least one of the inputs in order to increase the granularity of the input signal.

For example, the multiplier 301a may multiply a received measurement clock signal of 10 Mhz by a non-zero integer, in this case by ten, resulting in a modified measurement clock frequency of 100 Mhz; similarly, the multiplier 301b may multiply a received oscillator clock signal of 20 Mhz by a non-zero integer, such as eight, resulting in a modified oscillator clock frequency of 160 Mhz. In this example, a timer sampling period, such as 0.1 s, would be evenly divisible by the nominal cycle period of the modified oscillator clock signal. The modified oscillator clock signal may also be referred to as the target signal within the context of the PEC 300. In some embodiments, the non-zero value used by the multipliers 301a-b may be set by a controller, such as a controlling processor embodied by the CPU 107, 207.

Timer 303 may receive the modified measurement clock signal and may produce a sampling signal based on the modified measurement clock signal. Timer 303 may be a circuit, such as a binary counter composed of D-type flip-flops that will increment on the active edge of the modified measurement clock signal, wrapping around once its Terminal Count (TC) is reached. In the illustrative embodiment, the timer 303 may produce a timer signal from its TC output to the CPU Interface 315 and to the edge detector 305. In some embodiments, the timer 303 may set the timer sampling period from which the PEC 300 measures a target signal, which may be the modified oscillator clock signal, and may also synchronize the target signal with the modified measurement clock signal. Timer 303 may also set a nominal sampling rate to have a period that may be evenly divisible by the timer sampling period. In some embodiments, the timer sampling rate may be configured by the CPU.

Edge detector 305 may synchronize the sampling signal from the timer 303 to the clock domain of the modified oscillator signal (hereinafter, “the target signal”) clock domain. Edge detector 305 may be a D flip-flop circuit that may produce a synchronous one-clock-cycle pulse when triggered by a rising and/or falling edge of an input signal. In some embodiments, the PEC 300 may count the number of target signal clock cycles during the target period, which may be defined as the time between pulses generated by the edge detector 305. In the illustrative embodiment, for example, the edge detector 305 may produce a pulse whenever it receives a rising or falling edge from the timer 303.

Latch 309 may save values transmitted by the counter 311 based on signals received by the target signal and the edge detector 305. In some embodiments, the latch 309 may include sequential logic that receives that output of the edge detector 305 as an enable signal and the target clock signal as the controlling clock signal. In such instances, the latch 309 may use these received signals as control signals that indicate when to store, transmit, and overwrite data received from the counter 311. In some embodiments, the latch 309 may comprise a plurality of flip-flops that may enable storage of multiple bits of information. For example, in the illustrative embodiment, the latch 309 may store 32 bits, matching the 32-bit output of the oscillator phase difference counter 311.

Counter 311 may produce a counter number based on the target signal and the modified measurement clock signal. In some embodiments, the counter 311 may be a circuit including sequential logic that may count up during regular edges (rising or falling) of the target signal, and may periodically subtract a nominal value from its current value upon a sampling pulse event using the subtractor 313. The nominal value may be defined as an estimated count value relative to the modified measurement clock when the target signal frequency is without error and perfectly synchronous to the modified measurement clock. During regular operation, the counter may receive as an input an oscillator phase difference that is equal to the difference between the previous output of the counter 311 and a pre-calculated nominal value. The phase error may also include a quantization error that may be inherent to the circuit.

Subtractor 313 may receive, as inputs, the counter number from the counter 311, as well as the nominal value, which may be based on the modified measurement clock signal and the target period. Subtractor 313 may produce an oscillator phase difference based on these inputs. Subtractor 313 may be, for example, at least one comparator or similar logic circuit that produces a value based on the difference of received input values and/or signals. Subtractor 313 may produce either a positive or negative value, depending on the difference between the counter number and the expected value, and may output the value in the form of a phase-difference value back to the counter 311. When the counter number and the expected value are equal, this may produce a value of zero, that if persistent, signifies that the target signal and the measurement clock signal are synchronous. However, when a non-zero value is produced, this may signify a measured phase difference between the target signal and the modified measurement clock signal. In some instances, the non-zero value may also include quantization noise added by the circuit.

As an example, in the illustrative embodiment, the counter may count up during the target period established by the timer 303. In this instance, the target period may be 0.10 s, which may be a suitable rate, as it is evenly divisible by the nominal target signal cycle period of 160 Mhz. In the illustrative embodiment, the counter 311 may take 10 samples per second; the counter 311 may therefore be expected to count up to a value that is equal to the sum of target signal cycles during the target period; in this instance, the counter 311 expects a counter number of 16,000,000. This expected value may be the nominal value that is an input into the subtractor 313. When the target signal is synchronous in frequency and phase with the modified measurement clock signal, the counter 311 and subtractor 313 will produce a count of zero. However, a non-zero value produced by the subtractor 313 may represent a phase difference between the target signal and the modified measurement clock signal and may be reflected in the next counter number, which is then saved in the latch 309. The provided phase difference may also include circuit-induced errors, such as quantization error due to the nature of the sequential circuit. In some embodiments, such errors may be filtered by post-processing using the CPU 207.

CPU 207 may, for example, receive a stored value from the latch 309, as well as a latch-ready indication via CPU Interface 315, and may output the stored value from the latch 309 through the UI 109, 209 to a user. In some embodiments, the CPU 207 may perform further analysis before outputting results to a user. The latch-ready indication may be polled by the CPU 207; in other instances, the latch-ready indication may interrupt the CPU 207. In some embodiments, the CPU 207 may service the latch 309 at the sampling rate produced by the timer 303, and may average the stored values over a defined time period in order to filter out noise, such as quantization noise, that may have been included in the target signal.

The filtering method used by the CPU 207 may be based on the modified frequencies used and the behavior of the PEC 300. A person of skill in the art would be aware of different constructions of the PEC 300 and of applicable filtering methods used. CPU 207 may also use the stored value to produce other values through a plurality of analysis methods. For example, the CPU 207 may receive a stored value from the latch 309 representing a phase difference between the target signal and the modified measurement clock signal. CPU 207 may then filter the data over several samples, which may reduce the number of circuit-induced errors. CPU 207 may then use the outcome and a plurality of analysis methods to produce, for example, a frequency error value, a frequency deviation value, a time-interval error, a phase-noise error and similar derived values.

For example, the CPU 207 may calculate the frequency error value by first calculating an average PEC latched value over a defined period, which may be longer than the target period. CPU 207 may then calculate another average PEC latched value over a subsequent defined period; the CPU 207 may then calculate the difference between these two values (i.e., AvgCounter (n)−AvgCounter (n−1)). This difference value may then be multiplied by the target signal clock period and divided by the “defined period” (in units of seconds), which may produce the frequency error in units of Parts Per Billion (PPBs). Similarly, the CPU 207 may determine the frequency deviation by subtracting the initial frequency error value from successive frequency error values.

FIG. 4 illustrates another exemplary phase error counter. PEC 400 may act in a similar manner to PEC 300, with the PEC 400 using a different counting method to produce a difference value; this method may be used by the communications circuit 201, for example, when at least one of the input signals cannot be easily multiplied. PEC 400 may include components such as a multiplier 401a, a timer 403, an edge detector 405, a latch 409, and a CPU Interface 415, that may act in a similar manner to like-components in the PEC 300. In some embodiments, the PECs 300, 400 may share components, such as the multiplier 401a, the timer 403 and the CPU Interface 415. PEC 400 may also include a rate comparator 407 and a counter 411, whose operation is discussed in further detail below.

PEC 400 may receive a measurement clock signal and a target signal. However, in this embodiment, the target signal may not be modified through a multiplier. This may occur when the target signal may not be easily multiplied, for example, due to a high amount of jitter in the signal. PEC 400 may also be used by the communications circuit 101 to handle the measuring of low frequencies.

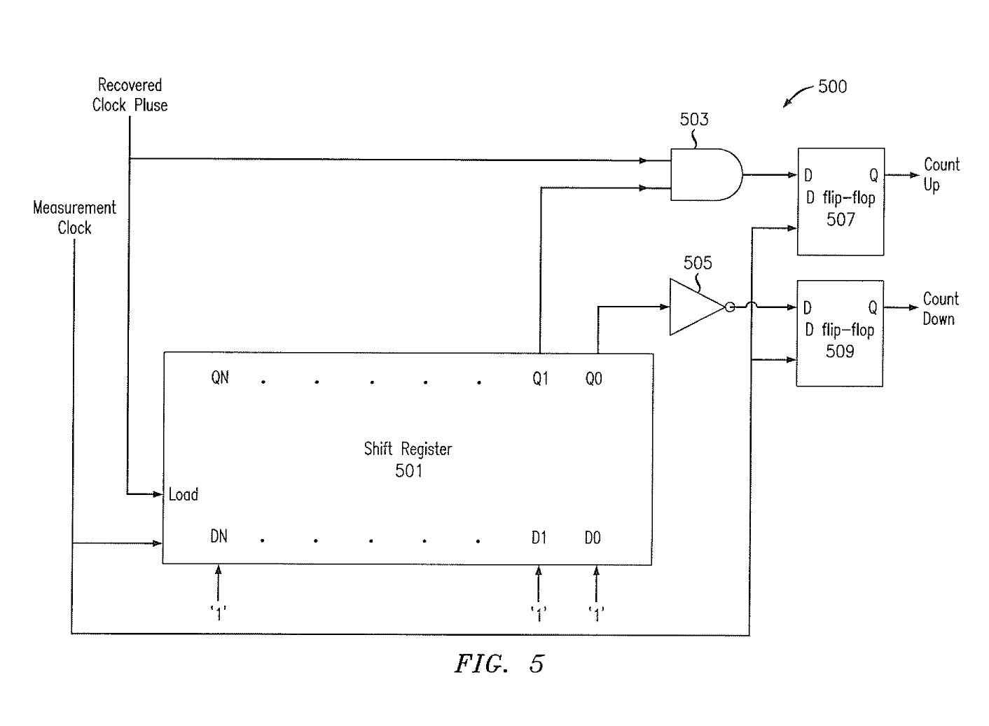

As will be discussed in further detail below in relation to FIG. 5, the rate comparator 407 may receive the modified measurement clock signal from the multiplier 401a and the target signal pulse from the edge detector 405. Rate comparator 407 may then track the difference between the measurement clock and the target signal in order to guide the counter 411 to count up or to count down or to not make a count. Counter 411 may send a counter number to the latch 409 at the end of a target period based on the received rate-difference indications from the rate comparator 407. Latch 409 may store the counter number and may then send the stored value to the CPU 207 via the CPU Interface 415. CPU 207 may use a plurality of analysis methods to derive other values from the stored value. The stored value may reflect a difference in phase and/or frequency between the target signal (in the illustrative embodiment, and within the context of phase error counter 400, the clock recovery function output) and the modified measurement clock signal.

FIG. 5 illustrates an exemplary rate comparator. Rate comparator 500 may be similar to the rate comparator 407 of the PEC 400 in FIG. 4 and may be used to measure a difference between a target signal pulse and a measurement clock signal. Rate comparator 500 may include a shift register 501, an AND logic gate 503, an inverter 505, and D flip-flops 507, 509. Based on the value found at the outputs of the shift register 501, the rate comparator may output a count-up or count-down signal to the counter 411, which may produce a counter number based on the accumulation of count-up and count-down signals.

Shift register 501 may include N register bits to track the rate difference between the modified measurement clock signal and the target signal pulse. In the illustrative embodiment, the shift register 501 may receive the modified measurement clock signal from the multiplier 401a and a recovered clock pulse from the edge detector 405. Shift register 501 may include N register bits, where N is equal to the nominal frequency of the modified measurement clock signal divided by the nominal frequency of the target signal (in the illustrative embodiment, the target signal may be the clock recovery module output signal). In some embodiments, the value of N may be an integer multiple, higher than two, of the target signal.

Shift register 501 may receive a pulse from the edge detector 405, which may be equal to the target signal frequency, but may be synchronized to the measurement clock domain. In some embodiments, the pulse produced from the edge detector 405 may represent a target signal clock cycle, such as the recovered clock cycle of the illustrative embodiment. Upon the reception of a pulse, the shift register 501 may load all N register bits with “1” values, with each bit representing T, which may be equal to the modified measurement clock period. In the illustrative embodiment, for example, a 100 Mhz measurement clock and a 10 Mhz recovered clock may use a 10-bit shift register with each bit representing 10 ns. In this instance, the 10-bit shift register 501 may represent a total of 100 ns of time.

Using the modified measurement clock signal, the shift register 501 may continuously shift between load pulses, with the Nth bit register filled with “0” values. When the target signal and the modified measurement clock signal are perfectly synchronous, a “0” will always reach the Q1 output, but never reach the Q0 output, as the loading of “0” into the Q0 output would be coincident with a load pulse from the edge detector 405, which may take precedence. When the target signal is slower than the measurement clock signal, a pulse from the edge detector 405 may be late and may result in a “0” value reaching the Q0 output, which may result in a count-down value from the D flip-flop 509. Similarly, when the target signal is faster than the measurement clock signal, a pulse from the edge detector 405 may occur early, and a “0” value may never reach the Q1 output. This may result in the production of a count-up value from the D flip-flop 507.

In some embodiments, the circuit may be extended to capture larger phase and/or frequency differences between the two clock domains. For example, a ‘1’ in bit position Q1 coincident with a target signal pulse may indicate that the target signal was faster than the measurement clock. This is may also be true for a ‘1’ value in Q2, Q3, Q4 positions, respectively, when found coincident with the sampling of the target signal pulse; each ‘1’ value found in a stage further to the left may signify a larger phase and/or frequency difference between the two signals. In such instances, a “count up by X” indication may be provided by the circuit to the counter instead of a simple “count up” signal (with X representing the Q-output stage furthest to the left that still contains a ‘1’ value coincident with the sampling of the target signal pulse).

Similarly, in order to measure greater magnitudes in the target signal being slower, additional shift register stages may be included to the right of Q0 (“Q-1,” “Q-2,” “Q-3,” etc.). In such embodiments, the furthest register to the right of Q1 holding a ‘0’ value coincident with the sampling of the target signal pulse may therefore represent the magnitude of the subtraction. In such instances, a “count down by Y” indication may therefore be provided to the counter, with “Y” equal to how far right of Q1 a ‘0’ value attained at the moment the target signal pulse was sampled. For example, a ‘0’ as far right as “Q-3” may represent a “count down by 4” indication towards the counter.

Referring now to FIG. 4, the counter 411 may be an up-down counter that receives both count-up and count-down values from the rate comparator 407 and may produce a counter number based on the quantity of count-up and count-down values received during a target period. This counter number may be saved by the latch 409, which may then send the stored value to the CPU 207 via the CPU interface 415 during specific times, controlled by the modified measurement clock signal and the signal generated by the timer 403.

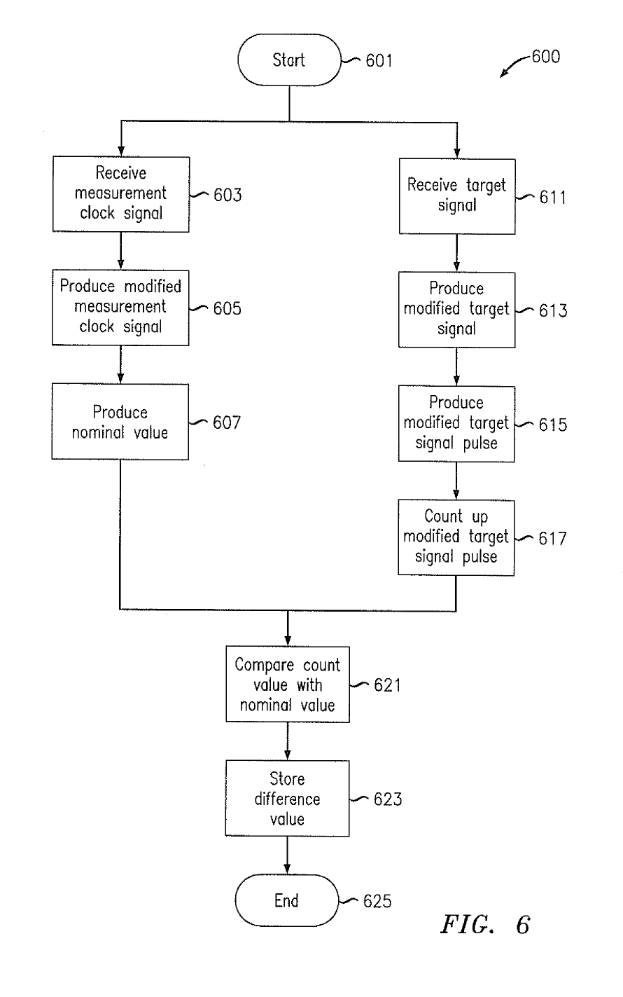

FIG. 6 illustrates a flowchart of an exemplary method to measure phase error. Method 600 may be implemented by the PEC 300 or to measure a high-frequency phase error. PEC 300 may, for example, use method 600 to measure an oscillator phase difference between a clock recovery reference oscillator, such as the reference oscillator 103, and the measurement clock signal. In some embodiments, a processor such as CPU 107 may use the resultant stored value to identify oscillator behavior may implement other analysis methods to produce other error values based on the measured phase error.

Method 600 may begin at step 601 and proceed to step 603, where the PEC 300 receives a measurement clock signal. Method 600 may then proceed to step 605, where a modified measurement clock signal is produced using the timer 303. In some embodiments, the modified measurement clock signal may be produced through a multiplier 301a as well as the timer 303. In step 607, a nominal value may be provided based on the target period set by the timer 303 and the modified measurement clock signal. The nominal value may be equal to the ideal number of target signal cycles during the target period. In some embodiments, the nominal value may be pre-calculated before the method 600 commences. The nominal value may be based, for example, on the frequency of at least the measurement clock signal. In some embodiments, the nominal value may remain static, while in alternate embodiments, when the CPU 107 may configure the applicable frequencies and sampling rates, the nominal value may be configurable as well.

In some embodiments, method 600 may also proceed to step 611 after step 601. In some embodiments, steps 603 and 611 and their subsequent steps may be done in parallel. In step 611, the PEC 300 may receive a target signal. In some embodiments, the target signal comprises the reference oscillator clock signal. In alternative embodiments, the target signal may comprise of a recovered clock signal that is based on the service clock transported over the timing-over-packet protocol. Method 600 may then proceed to step 613, where PEC 300 produces a modified target signal. In some embodiments, the modified target signal may be produced by a multiplier 301b. In step 615, the PEC 300 produces a modified target signal pulse at the edge detector 305 based on the modified target signal and the modified measurement clock signal. In some embodiments, the modified measurement clock signal may also be synchronized to the clock domain of the target signal. Method 600 may then proceed to step 617, where the counter 311 receives the modified target signal and counts up during the target period by counting the number of target signal clock cycles during the target period.

In step 621, comparison may be made between the count value produced in step 617 with the nominal value provided in step 607. For example, a comparison may include a subtractor 313 producing a difference value that is equal to the difference between the count value and the nominal value. When the difference value is equal to zero and is persistent between iterations, this may signify that the target signal frequency is without error and perfectly synchronous to the measured clock. When the difference value is a non-zero number, this may signify a phase difference between the target signal and the modified measurement clock signal. In some embodiments, the non-zero difference value may also include quantization noise introduced by the communications circuit 201. Method 600 may then proceed to step 623, where the difference value is stored in the latch 309. Method 600 may then end at 625. In some embodiments, the PEC 300 may repeat method 600 multiple times, as several samples may be required to filter out errors. In such instances, the PEC 300 may read and process the accumulated difference value in order to analyze the error over longer periods. In some embodiments, the difference value may be used by the CPU 107 in other analysis to produce other values derived from the difference value stored in the latch 309.

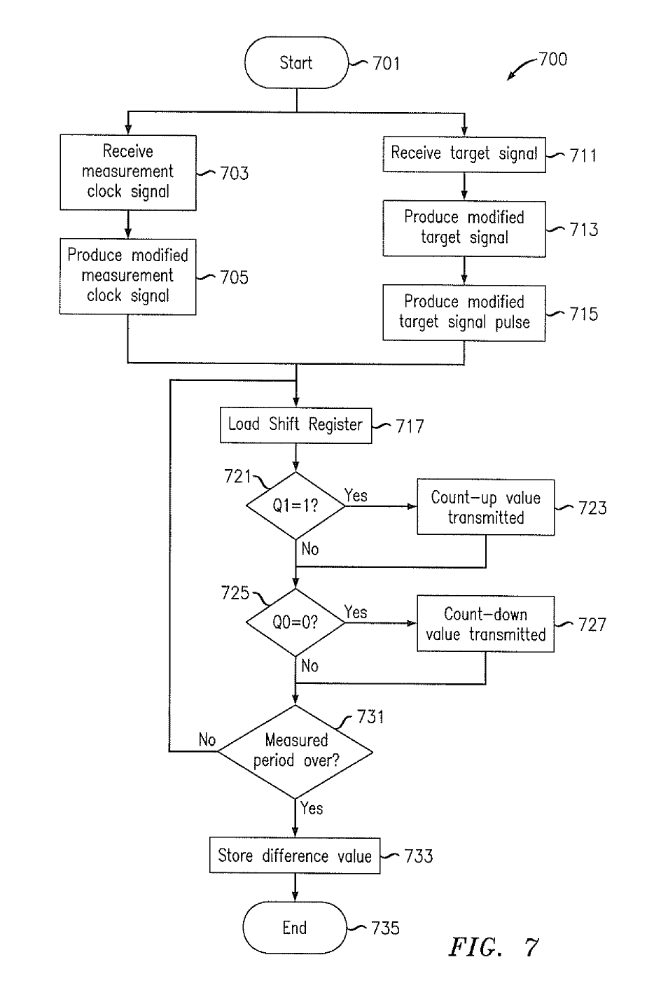

FIG. 7 illustrates a flowchart of another exemplary method to measure phase error. PEC 400 may implement method 700 for low-frequency signals or when one of the signals cannot be easily multiplied. In some embodiments, a PEC 300, 400 may be modified to implement both methods 600 and 700, depending on the target signal to be measured.

Method 700 may begin at step 701 and proceed to steps 703-705, which are similar to steps 603-605 of method 600 in FIG. 6. Similarly, steps 711-715 are similar to steps 611-615 and may also occur in parallel with steps 703-705. In step 717, the shift register 501 of the rate comparator 407 is loaded with “1” values at each register bit. This may occur upon receipt of a target signal pulse produced in step 715 from a target signal derived from the recovered clock signal.

Method 700 may then proceed to step 721, which may occur at the end of the target period, where the rate comparator 407 may compare the measurement clock signal and the target signal. In step 721, the output of the Q1 of the shift register 501 may be checked to see if there is a “1” value. If there is a value of “1” stored at Q1 at the end of the target period, this may indicate that the target signal pulse is being generated at a rate faster than the target period and the target signal is therefore faster than the modified measurement clock signal. As a result, the method 700 may proceed to step 723, where a count-up value is transmitted through the count-up flip-flop to the counter 411. Otherwise, the method 700 proceeds from step 721 to step 725.

In step 725, the Q0 output of the shift register 501 in the rate comparator 407 is checked to determine whether it contains a “0” value. If the Q0 output contains a “0” value, this may indicate that the target signal pulse is being generated at a rate slower than the target period and the target signal is therefore slower than the modified measurement clock signal. As a result, the method 700 may proceed to step 727, where a count-down value is transmitted through the count-down flip-flop to the counter 411. Otherwise, the method 700 proceeds from step 725 to step 731.

At step 731, the PEC 400 may determine whether the measured period is over. In some embodiments, the measured period may be longer than the target period in which the counter 411 may accumulate a plurality of count-up and/or count-down values from the shift register 501 before sending a difference value to the latch 409. When the measured period is not over, the method 700 may return back to 717 to load the shift register again with “1” values. In some embodiments, step 731 may occur upon the receipt of a subsequent pulse from the edge detector 405 in step 715. When the measured period is over, the method 700 may proceed to step 733, where the latch 409 stores the difference value produced in the counter 411. Method 700 may then end at step 735. In some embodiments, the PEC 400 may repeat method 700 multiple times, as several samples may be required to filter out errors. In such instances, the PEC 400 may read and process the accumulated difference value in order to analyze the error over longer periods. In some embodiments, the CPU 107 may use the difference value stored in the latch 409 in other analysis to produce other values derived from the difference value.

It should be apparent from the foregoing description that various exemplary embodiments of the invention may be implemented in hardware and/or firmware. Furthermore, various exemplary embodiments may be implemented as instructions stored on a tangible machine-readable storage medium, which may be read and executed by at least one processor to perform the operations described in detail herein. A tangible machine-readable storage medium may include any mechanism for storing information in a form readable by a machine, such as a personal or laptop computer, a server, or other computing device. Thus, a tangible machine-readable storage medium may include read-only memory (ROM), random-access memory (RAM), magnetic disk storage media, optical storage media, flash-memory devices, and similar tangible storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in tangible machine readable media and so executed by a specialized computer or processor, whether or not such a specialized computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

We claim:

1. An apparatus that measures internal clock performance, the apparatus comprising:
an interface that receives a measurement clock signal from a measurement clock;
a timing circuit comprising:
a reference oscillator, wherein the timing circuit uses the reference oscillator for timing operations; and
a first measurement circuit that measures an oscillator phase difference between a reference oscillator clock signal produced by the reference oscillator and the measurement clock signal.

2. The apparatus of claim 1, further comprising:
a clock recovery module in the timing circuit that receives timing packets and outputs a recovered clock; and
a second measurement circuit that measures a clock recovery phase difference between a recovered clock signal based on the recovered timing packets and the measurement clock signal.

3. The apparatus of claim 1, further comprising:
a clock recovery module in the timing circuit that receives timing packets and outputs a recovered clock, wherein the first measurement circuit further measures the clock recovery phase difference between a recovered clock signal based on the recovered timing packets and the measurement clock signal.

4. The apparatus of claim 1, wherein the first measurement circuit comprises:
a timer that produces a sampling rate that triggers at the beginning of a target period, wherein the target period is based on the measurement clock signal;
a counter that increases a target count by throughout the target period based on a frequency of a target signal; and
a subtractor that produces the oscillator phase difference by subtracting an estimated value from the target count, wherein the estimated value is equal to the ideal number of target signal cycles during the target period.

5. The apparatus of claim 2, wherein the second measurement circuit comprises:
a timer with a sampling rate that triggers at the beginning of a target period, wherein the target period is based on the measurement clock signal; and
a counter comprising:
a rate comparator that comprising an up-down counter that produces a count-up value or a count-down value based on the measurement clock signal and the recovered clock.

6. The apparatus of claim 4, wherein the target signal is the recovered clock signal.

7. The apparatus of claim 4, wherein the target signal is the oscillator clock signal.

8. The apparatus of claim 1, further comprising:
a central processing unit (CPU) that produces a performance value from the oscillator phase difference.

9. The apparatus of claim 2, further comprising:
a central processing unit (CPU) that produces a performance value from the clock recovery phase difference.

10. The apparatus of claim 1, further comprising:
a user interface (UI) that outputs the oscillator phase difference from the timing circuit to a user and receives user commands.

11. A method to measure internal clock performance, the method comprising:
receiving, by a first measurement circuit in a communication circuit, a reference oscillator clock signal from a reference oscillator included in a timing circuit within the communications circuit;
receiving a measurement clock signal received through an interface from a measurement clock; and
measuring an oscillator phase difference between the reference oscillator signal and the measurement clock signal.

12. The method of claim 11, further comprising:
receiving timing packets;
producing, by a clock recovery module in the timing circuit, a recovered clock signal based on the recovered clock timing packets;
receiving, by a second measurement circuit in the communications circuit, the measurement clock signal;
receiving, by the second measurement circuit, the recovered clock signal; and
measuring, by the second measurement circuit, a clock recovery phase difference between the measurement clock signal and the recovered clock signal.

13. The method of claim 11, further comprising:
receiving timing packets;
producing, by a clock recovery module in the timing circuit, a recovered clock signal based on the recovered clock timing packets;
receiving, by the first measurement circuit, a measurement clock signal;
receiving, by the first measurement circuit, the recovered clock signal; and
measuring, by the first measurement circuit, a clock recovery phase difference between the measurement clock signal and the recovered clock signal.

14. The method of claim 11, wherein the first measurement circuit comprises:
a timer that produces a sampling rate that triggers at the beginning of a target period, wherein the target period is based on the measurement clock signal;
a counter that increases a target count by throughout the target period based on a frequency of a target signal; and
a subtractor that produces the oscillator phase difference by subtracting an estimated value from the target count, wherein the estimated value is equal to the ideal number of target signal cycles during the target period.

15. The method of claim 12, wherein the second measurement circuit comprises:
a timer with a sampling rate that triggers at the beginning of a target period, wherein the target period is based on the measurement clock signal; and
a counter comprising:
a rate comparator that comprising an up-down counter that produces a count-up value or a count-down value based on the measurement clock signal and the recovered timing packets.

16. The method of claim 14, wherein the target signal is the recovered clock signal.

17. The method of claim 14, wherein the target signal is the oscillator clock signal.

18. The method of claim 11, further comprising:
producing, by a central processing unit (CPU) in the communications circuit, a performance value from the oscillator phase difference.

19. The method of claim 12, further comprising:
producing, by a central processing unit (CPU) in the communications circuit, a performance value from the clock recovery phase difference.

20. The method of claim 11, further comprising:
outputting, from a user interface (UI) to a user, the oscillator phase difference from the timing circuit; and
receiving, by the UI from the user, at least one user command.
